(19) United States
(12) Patent Application Publication
(10) Pub. No.: US 2013/0135868 A1
(43) Pub. Date: May 30, 2013

(54) LIGHTING DEVICE

(71) Applicants: Jian Xue, Shanghai (CN); Yanmeng Sun, Shanghai (CN); Meike Yavuz, Eindhoven (NL)

(72) Inventors: Jian Xue, Shanghai (CN); Yanmeng Sun, Shanghai (CN); Meike Yavuz, Eindhoven (NL)

(73) Assignee: KONINKLIJKE PHILIPS ELECTRONICS NV, EINDHOVEN (NL)

(21) Appl. No.: 13/814,408

(22) PCT Filed: Aug. 1, 2011
(86) PCT No.: PCT/IB11/53409

§ 371 Date: Feb. 5, 2013

(30) Foreign Application Priority Data
Aug. 9, 2010 (CN) PCT/CN2010/075820

(51) Int. Cl. F21V 29/00

(52) U.S. Cl. CPC F21V 29/2206
USPC 362/249.02; 362/382

(57) ABSTRACT

The invention provides a lighting device comprising a light source unit (50), a ventilator unit (30) and a heat dissipating unit (40), wherein the heat dissipating unit comprises a main body (400) having a first surface (401) and a second surface (402), at least one first aperture (403), at least one second aperture (404) and a first set of fins (405) attached to the second surface. The at least one first aperture is formed by perforating the first surface and the second surface, and the at least one second aperture is located around the at least one first aperture at a distance therefrom. At least one fin is configured in arc shape extending from the first aperture toward the second aperture and the ventilator unit is positioned to cover at least part of the fins. Thus, the heat dissipating efficiency is improved because a greater airflow passes through the heat dissipating unit due to a high flow speed resulting from the low resistance.

### FIELD OF THE INVENTION

The present invention relates to a lighting device comprising a light source unit, a ventilator unit and a heat dissipating unit. Especially, the light source unit comprises one or more light emitting diodes (LEDs).

### BACKGROUND OF THE INVENTION

Light emitting diodes (LEDs) are widely applied in various applications including utility lighting. LED lamps are regarded as representing the future of light sources and have been applied on a worldwide scale in recent years, and they will become more popular in the future as they will replace traditional lamps because of the advantages of a high efficiency and a potentially long lifetime.

However, considerable heat is generated by LEDs in lighting applications. It is well known that this thermal issue is considered to be a bottleneck that restricts both optical output and lifetime of the LED lamp. The performance and lifetime of LED lamps will be degraded when excessive heat cannot be dissipated.

To dissipate excessive heat, various heat dissipation means are proposed in the industry. Generally, these heat dissipation means can be classified as active cooling structures and passive cooling structures. For some active cooling structures, commonly an electric fan is employed and some heat dissipating fins are arranged around the fan for heat exchange purposes. Such a fin structure can yield a better thermal performance in big volume conditions with a strong fan. But for compact LED lamps, it may have an adverse impact on the heat dissipation due to the high flow resistance inside the lamps and thus decrease the lifetime and optical output of the LED lamps. Meanwhile, noise generated by the airflow and the fan is another eternal topic.

### SUMMARY OF THE INVENTION

It is an object of the present invention to provide a lighting device, wherein the performance of its active cooling, especially by means of an electric fan, is improved, while the noise level is simultaneously lowered.

According to an embodiment of the present invention, the lighting device comprises a light source unit, a ventilator unit and a heat dissipating unit, wherein the heat dissipating unit comprises a main body having a first surface and a second surface, at least one first aperture, at least one second aperture and a first set of fins attached to the second surface. The light source unit is positioned on the first surface. The at least one first aperture is formed by perforating the first surface and the second surface, and the at least one second aperture is located around the at least one first aperture at a distance therefrom. At least one fin is configured in arc shape extending from the first aperture toward the second aperture and the ventilator unit is positioned to cover at least part of the fins.

By having the arc-shaped fin extend from the first aperture toward the second aperture, an airflow channel can be formed between two adjacent fins and such an airflow channel is also arc shaped. Thus, the airflow generated by the ventilator unit can smoothly pass through the channel, thereby decreasing the resistance and noise when the air passes among the fins. Accordingly, the heat dissipating efficiency is improved because a greater airflow passes through the heat dissipating unit due to a high flow speed resulting from the low resistance.

Alternatively, the fins are interconnected one by one at an end of each fin by means of a plate, which end faces away from the first aperture. In this case, the first aperture and the second aperture are isolated by the plate and air cannot flow from the first aperture to the second aperture or from the second aperture to the first aperture through the airflow channel. Consequently, either one of the first aperture and the second aperture serves as air inlet and the other one serves as air outlet, and the comparatively cool air from the inlet and the comparatively hot air to be dissipated through the outlet will not be mixed, and hot air will be discharged from the outlet directly instead of being carried by the cool air into the heat dissipating unit again.

Alternatively, the at least one first aperture serves as air outlet and the at least one second aperture serves as air inlet, and the ventilator unit is employed for moving air from the second aperture (i.e. air inlet) through the ventilator unit to the first aperture (i.e. air outlet). When the total area of the air inlet is bigger than that of the air outlet, the flow speed of air out of the heat dissipating unit will be larger than that of air into the heat dissipating unit. Consequently, the hot air discharged from the air outlet will not be sucked into the heat dissipating unit.

### BRIEF DESCRIPTION OF THE DRAWINGS

The above and other objects and features of the present invention will become apparent from the following detailed description of the various embodiments with reference to the accompanying drawings.

FIG. 1 is an exploded perspective view of the lighting device according to a first embodiment of the invention;

FIG. 2 is a bottom view of the heat dissipating unit of the lighting device shown in FIG. 1;

FIG. 3 is a perspective view of the heat dissipating unit of the lighting device shown in FIG. 1;

FIG. 4 is a cross sectional view of the lighting device as shown in FIG. 1, with a flow of air in an exemplary direction;

FIG. 5 is a perspective view of the heat dissipating unit of the lighting device according to a second embodiment of the invention.

### DETAILED DESCRIPTION OF EMBODIMENTS

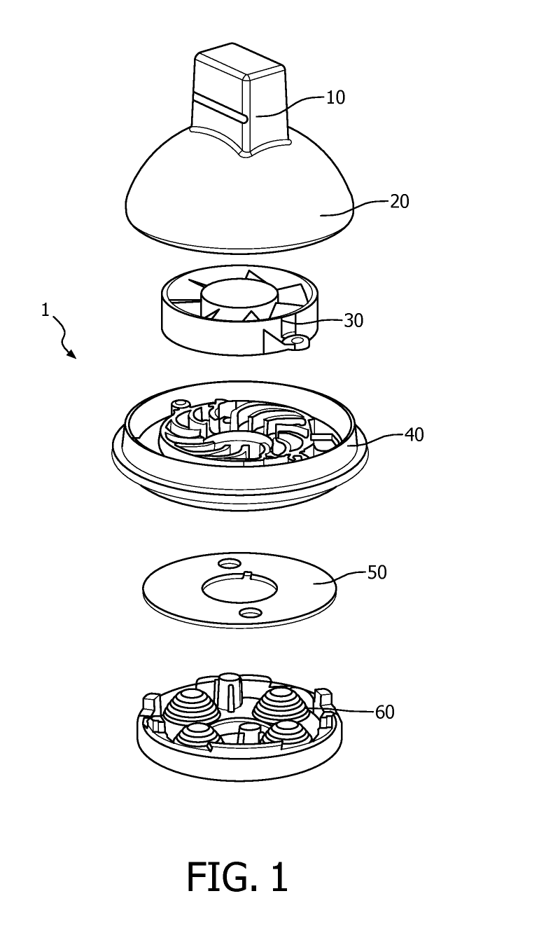

FIGS. 1 through 4 illustrate a lighting device according to a first embodiment of the invention. The lighting device 1 comprises a socket 10, a cup-shaped housing 20 connected to the socket 10, a ventilator unit 30, a heat dissipating unit 40, a light source unit 50 and an optical unit 60. The housing 20 is capable of accommodating a driving circuit (not shown), which is electrically connected to an external electric power source via the socket 10 and can supply proper electric power to the light source unit 50. The optical unit 60 is used to receive the light emitted from the light source unit 50 and then transfer the received light into a desired radiation pattern.

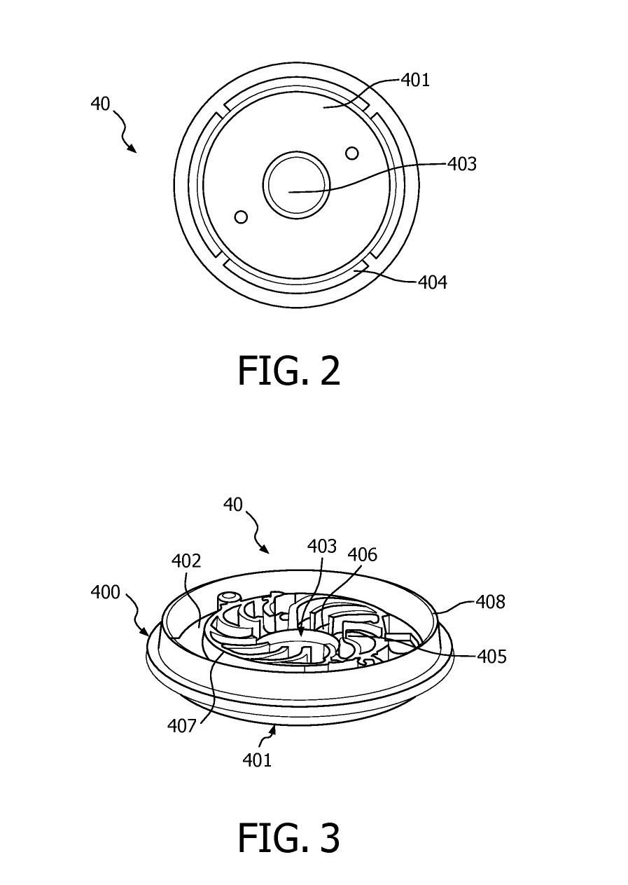

FIGS. 2 and 3 illustrate the heat dissipating unit 40 according to the first embodiment of the present invention. The heat dissipating unit 40 comprises a main body 400 having a first surface 401 on one side of the main body 400 and a second surface 402 on the other side of the main body 400 opposite to the above mentioned side. The light source unit 50 is positioned on the first surface 401.

The heat dissipating unit 40 further comprises one first aperture 403 and four second apertures 404. The first aperture 403 is centrally located in the main body 400 and is formed by perforating the first surface 401 and the second surface 402. Similarly, the four second apertures can be formed by perforating the first surface and the second surface. The four second apertures 404 are located around the first aperture 403 at a distance therefrom and form a circle-shaped space on the first and the second surface 401 and 402, respectively. Thus, the light source unit 50 can be positioned in a circle-shaped form on the circle-shaped space of the first surface 401, wherein the first aperture 403 is located within the circle-shaped form, while the four second apertures are located outside the circle-shaped form. As shown in FIG. 2, the first aperture 403 is circle-shaped and each of the second apertures 404 is a gap along the circumferential direction of the main body 400, which gaps are positioned one after another to form a circular gap with four obstructions.

The number and shape of the first aperture 403 and the second apertures 404 given above are only exemplary and can be varied based on various practical situations. For example, the second aperture 404 can be made up of one circular gap without obstruction or more consecutive co-axial circular gaps, or a plurality of holes.

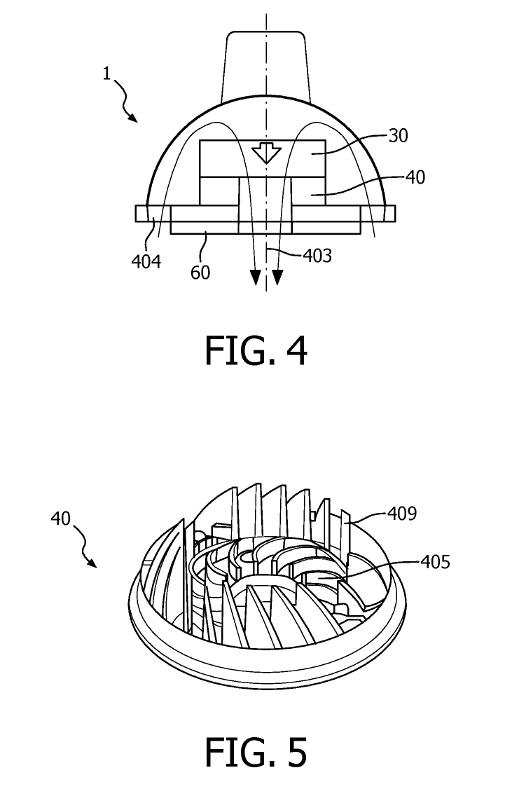

In this embodiment, as shown in FIG. 4, the first aperture 403 serves as air outlet and the second apertures 404 serve as air inlet. Thus, it is generally easy to achieve that the total area of the air inlet is bigger than that of the air outlet, which will result in the flow speed of air out of the heat dissipating unit being higher than that of air into the heat dissipating unit. Consequently, the hot air will not be sucked into the heat dissipating unit. In another embodiment, the first aperture 403 can also serve as air inlet and the second apertures 404 as air outlet.

The ventilator unit 30 is employed for moving air from the air inlet through the ventilator unit 30 to the air outlet. Consequently, by means of the ventilator unit 30, comparatively cool air can be drawn into the lighting device 1 through the second apertures 404 (i.e. air inlet) from the room where the lighting device 1 is located, and the cool air will have heat exchange with the heat dissipating unit 40 and become comparatively hot, after which it is vented out of the lighting device 1 through the first aperture 403 (i.e. air outlet).

The heat dissipating unit 40 further comprises a first set of fins 405 attached to the second surface 402, and each of the fins 405 is configured in arc shape extending from the first aperture 403 toward the second aperture 404. A plurality of fins 405 is located between the first aperture 403 and the second aperture 404 and there is a certain distance between two adjacent fins 405. The specific fin configuration, e.g. the fin's curvature, the number of fins, fin height, the mentioned distance and other parameters, can be optimized based on the direction of the airflow from the ventilator unit 30, the temperature requirement of the lighting device 1, the heat generated by the light source unit 50 and other factors.

An air flow channel 406 is formed between two adjacent fins 405 and such an airflow channel 406 is also arc shaped. Thus, the flow resistance in such an arc shaped channel is greatly decreased as the direction of the air flow is commonly tortuous rather than straight. Therefore, the airflow generated by the ventilator unit 30 can smoothly pass through the channel 406; thereby noise is decreased when the air passes through the fins 405. Accordingly, the heat dissipating efficiency is improved because a greater airflow passes through the heat dissipating unit 40 due to a higher flow speed resulting from the low resistance.

Alternatively, the fins 405 are interconnected one by one at an end of each fin 405 by means of a plate 407, which end faces away from the first aperture 403. In this case, the first aperture 403 and the second aperture 404 are isolated by the plate 407 and air cannot flow from the first aperture 403 to the second aperture 404 or from the second aperture 404 to the first aperture 403 through the airflow channel 406. Consequently, either one of the first aperture 403 and the second aperture 404 serves as air inlet and the other one serves as air outlet, and the cool air from the inlet and the hot air to be dissipated through the outlet will not be mixed and hot air will directly be discharged via the outlet instead of being carried by the cool air into the heat dissipating unit.

Alternatively, the heat dissipating unit 40 may further comprise a salient part 408 for connecting with the housing 20. In another embodiment, there may be other connecting means for connecting the heat dissipating unit 40 to the housing 20.

The ventilator unit 30 is positioned to cover at least part of the fins 405. Preferably, the ventilator unit 30 is positioned parallel to the second surface 402 and properly covers all the fins 405.

The proposed configuration of the heat dissipating unit 40 will have a better heat dissipating performance and the light device 1 as a whole will have a lower noise level when the ventilator unit 30 comprises an axial electric fan, because most of the air from the ventilator unit 30 will pass through the first set of fins 405 and the axial electric fan commonly has a lower noise level compared with other types of electric fan. The performance can be optimized when the curve direction of each of the fins 405 is similar to the direction of the airflow from the axial electric fan.

The light source unit 50 is capable of emitting certain spectral radiation, and it comprises one or more LEDs. Alternatively, the light source unit 50 can comprise other light sources like OLEDs.

For the lighting device 1 proposed in the first embodiment, it has advantages like lower temperature and noise levels due to a higher air outlet velocity resulting from the lower flow resistance in the heat dissipating unit 40. For such a lighting device 1 with LEDs as the light source, 20 samples have been tested and it was found that the thermal resistance was below 5 w/m.K and the sound intensity of all samples was less than 25 dB, which is lower than 30 dB as required by the corresponding US standard. Furthermore, additional heat dissipating fins, which are commonly attached on the outside surface of the heat dissipating unit to increase the heat dissipating area, are not necessary, and accordingly the manufacturing cost of the heat dissipating unit can be reduced.

FIG. 5 is a perspective view of a second embodiment of the heat dissipating unit of the lighting device. Compared with the heat dissipating unit 40 shown in FIG. 3, the heat dissipating unit 40 shown in FIG. 5 further comprises a second set of fins 409, which are positioned around the first set of fins 405 and form a cavity to accommodate the ventilator unit 30. The fin 409 of the second set can be arc shaped just like the shape of the first set of fins 405; or it can be a straight fin. Alternatively, the fin 409 can have the same height as or a lower height than the fins 405. The second set of fins 409 increases the heat exchange surface and can improve the thermal efficiency of the heat dissipating unit 40.

The embodiments described above are merely preferred embodiments of the present invention. Other variations of the disclosed embodiments can be understood and effected by those skilled in the art in practicing the claimed invention, from a study of the drawings, the disclosure, and the appended claims. These variations shall also be considered to be within the scope of the present invention. In the claims and description, use of the verb “comprise” and its conjugations does not exclude other elements or steps, and the indefinite article “a” or “an” does not exclude a plurality.

1. A lighting device comprising a light source unit, a ventilator unit and a heat dissipating unit, wherein the heat dissipating unit comprises:
a main body having a first surface and a second surface, wherein the light source unit is positioned on the first surface;
at least one first aperture and at least one second aperture, wherein the at least one first aperture is formed by perforating the first surface and the second surface, and the at least one second aperture is located around the at least one first aperture at a distance therefrom, and the at least one first aperture and the at least one second aperture are set on the same side of the ventilator unit;
a first set of fins attached to the second surface, wherein at least one fin is configured in arc shape extending from the first aperture toward the second aperture, an air flow channel is formed between two adjacent fins and such an airflow channel is also arc shaped, and the ventilator unit is positioned to cover at least part of the fins.

2. The lighting device according to claim 1, wherein the fins are interconnected one by one at an end of each fin by means of a plate, which end faces away from the first aperture.

3. The lighting device according to claim 1, wherein the ventilator unit comprises an axial electric fan.

4. The lighting device according to claim 3, wherein each of the fins has a curve direction similar to the direction of the airflow from the electric fan.

5. The lighting device according to claim 1, wherein the heat dissipating unit further comprises a second set of fins which are positioned around the first set of fins and form a cavity to accommodate the ventilator unit.

6. The lighting device according to claim 1, wherein the light source unit is positioned in a circle-shaped form, wherein the at least one first aperture is located inside the circle-shaped form, whilst the at least one second aperture is located outside the circle-shaped form.

7. The lighting device according to claim I, wherein the at least one first aperture serves as air outlet and the at least one second aperture serves as air inlet, and the ventilator unit is employed for moving air from the second aperture through the ventilator unit to the first aperture.

8. The lighting device according to claim 7, wherein the total area of the second aperture is bigger than that of the first aperture.

9. The lighting device according to claim I, wherein each fin of the first set of fins is configured in arc shape extending from the first aperture toward the second aperture.

10. The lighting device according to claim I, wherein the light source unit comprises at least one LED.
